(19) United States
(12) Patent Application Publication
(10) Pub. No.: US 2016/0124629 A1
(43) Pub. Date: May 5, 2016

(54) MICRO-CUSTOMIZABLE RADIO SUBSCRIPTION SERVICE

(71) Applicant: LOBE VENTURES INC, Pembroke Pines, FL (US)

(72) Inventor: Angel Guillermo Zambrano Perozo, Pembroke Pines, FL (US)

(21) Appl. No.: 14/931,616

(22) Filed: Nov. 3, 2015

Related U.S. Application Data
(60) Provisional application No. 62/074,998, filed on Nov. 4, 2014.

(51) Int. Cl. G06F 3/0484; G06F 17/30; G06Q 20/28; H04L 29/08; G06Q 20/12

(52) U.S. Cl. CPC G06F 3/04847; H04L 67/306; G06Q 20/1235; G06Q 20/28; G06F 3/04842; G06F 17/30029

(57) ABSTRACT

Described herein are systems, media, methods, and platforms including modules for presenting an interface allowing a user to set music content preferences by selecting one or more styles and one or more genres; modules for presenting an interface allowing a user to set non-music content preferences by selecting one or more genres and setting a non-music content schedule; modules for presenting an interface allowing a user to adjust a mix of music styles and a mix of music to non-music content in the radio subscription; and modules for presenting a programming clock showing played and upcoming music and non-music content, based on the preferences, the mixes, and the schedule, for each hour; provided that the radio subscription music and non-music content is downloaded with pre-payment of digital rights and is available for offline playback.

### CROSS-REFERENCE TO RELATED APPLICATIONS

This application claims the benefit of U.S. patent application Ser. No. 62/074,998, filed Nov. 4, 2014, the entire disclosure of which is hereby incorporated herein by reference.

### BACKGROUND OF THE INVENTION

Radio became prominent in the early 20th century as a method of transmitting information, such as sound, though modification of properties of radiated waves that can be extracted and transformed back to its original form. Radio is commonly used to broadcast audio, including news, music, sports, talk, and emergency notifications. The Internet is a global system of interconnected computer networks used to link billions of devices worldwide. Rapid growth of the Internet began in the 1990's, and over one-third of the world's population is currently connected to the Internet. The Internet provides an extensive and exciting platform for broadcasting radio services.

### SUMMARY OF THE INVENTION

Internet radio is an audio service transmitted via the Internet and is integrated into many online music subscription services. Commercially available Internet radio services and online music subscription services include, by way of non-limiting examples, SPOTIFY®, RDIO®, DEEZER®, MIXCLOUD®, MYSPACE®, QOBUZ®, RHAPSODY®, SOUNDCLOUD®, TIDAL®, PANDORA®, SLACKER®, TuneIn, IHEARTRADIO®, Dash Radio, Jango, LIVE365®, GROOVESHARK®, AMAZON® Prime Music™, Apple Music™, Google Play™, SONY MUSIC®, and XBOX® Music. Current technology within this field creates radio stations around a song, album, artist or genre. Once a station is created, a user may skip undesirable songs. In some instances, users may create their playlists and share these playlists with friends or over social media, and users may follow other users, friends, or artists.

Despite the features provided by the current technology, serious deficiencies exist, for example, the user is limited to a unidirectional passive experience. The current technology is predominantly stream-based and subscription-based, and users typically set a playlist and allow the playlist to run its course with little further input. Users have limited ability to rewind, repeat, scrub forward, or select specific songs for their stations. Changing between different types of media, for example between music and news, generally requires users to select a different station, channel, or playlist. Because many services are stream-based, a disruption in Internet connectivity results in a disruption in the broadcast. Moreover, when a user's subscription terminates, the user will likely lose access to their personalized media library.

The subject matter disclosed herein is a micro-customizable radio subscription service. In some embodiments, the service offers users extensive control of their media content, allowing users to customize a mix of music styles and a mix of music and non-music content, schedule broadcast times, adapt their content based on social activity, download their playlist with pre-payment of digital rights such that the media is available for offline playback, and adjust numerous other settings and preferences. As such, the subject matter described herein provides for an active, engaging, and uninterrupted user experience that is individualized to the user.

In one aspect, disclosed herein are computer-implemented systems comprising: a digital processing device comprising an operating system configured to perform executable instructions and a memory; a computer program including instructions executable by the digital processing device to create a micro-customizable radio subscription application comprising: a software module presenting an interface allowing a user to set music content preferences by selecting one or more styles and one or more genres; a software module presenting an interface allowing a user to set non-music content preferences by selecting one or more genres and setting a non-music content schedule; a software module presenting an interface allowing a user to adjust a mix of music styles and a mix of music to non-music content in the radio subscription; and a software module presenting a programming clock showing played and upcoming music and non-music content, based on the preferences, the mixes, and the schedule, for each hour; provided that the radio subscription music and non-music content is downloaded with pre-payment of digital rights and is available for offline playback. In some embodiments, the radio subscription music and non-music content is customized for the user based on inputs comprising: the preferences and the mixes. In further embodiments, the radio subscription music and non-music content is customized for the user based on inputs further comprising: curation by an administrator, market data, the user's behavior within the application, the behavior of others in the user's social graph, and the user's social activity. In some embodiments, the interface allowing a user to set music content preferences allows the user to select or delete songs from a list of songs derived from selected styles and genres. In some embodiments, the interface allowing a user to adjust a mix of music styles and a mix of music to non-music content in the radio subscription comprises slider interface elements to adjust each mix. In some embodiments, the programming clock comprises a circular interactive interface allowing the user to replay played content and jump ahead to upcoming content within a programming hour. In some embodiments, the non-music content schedule comprises one or more preferred days of the week and a preferred time of day.

In another aspect, disclosed herein are micro-customizable radio subscription platforms comprising: a mobile processor configured to provide a mobile application comprising: a software module presenting an interface allowing a user to set music content preferences by selecting one or more styles and one or more genres; a software module presenting an interface allowing a user to set non-music content preferences by selecting one or more genres and setting a non-music content schedule; a software module presenting an interface allowing a user to adjust a mix of music styles and a mix of music to non-music content in the radio subscription; and a software module presenting a programming clock showing played and upcoming music and non-music content, based on the preferences, the mixes, and the schedule, for each hour; a server processor configured to provide a server application comprising: a software module customizing radio subscription music and non-music content for the user based on the preferences and the mixes; and a software module delivering the customized radio subscription music and non-music content to the mobile application via download with pre-payment of digital rights, wherein the content is available for offline playback. In some embodiments, the radio subscription music and non-music content is customized for the user based on inputs comprising: curation by an administrator, market data, the user's behavior within the application, the behavior of others in the user's social graph, and the user's social activity. In some embodiments, the interface allowing a user to set music content preferences allows the user to select or delete songs from a list of songs derived from selected styles and genres. In some embodiments, the interface allowing a user to adjust a mix of music styles and a mix of music to non-music content in the radio subscription comprises slider interface elements to adjust each mix. In some embodiments, the programming clock comprises a circular interactive interface allowing the user to replay played content and jump ahead to upcoming content within a programming hour. In some embodiments, the non-music content schedule comprises one or more preferred days of the week and a preferred time of day.

In another aspect, disclosed herein are non-transitory computer-readable storage media encoded with a computer program including instructions executable by a processor to create a micro-customizable radio subscription application comprising: a software module presenting an interface allowing a user to set music content preferences by selecting one or more styles and one or more genres; a software module presenting an interface allowing a user to set non-music content preferences by selecting one or more genres and setting a non-music content schedule; a software module presenting an interface allowing a user to adjust a mix of music styles and a mix of music to non-music content in the radio subscription; a software module presenting a programming clock showing played and upcoming music and non-music content, based on the preferences, the mixes, and the schedule, for each hour; and a software module provided that downloading the radio subscription music and non-music content with pre-payment of digital rights such that the content is available for offline playback. In some embodiments, the radio subscription music and non-music content is customized for the user based on inputs comprising: the preferences and the mixes. In further embodiments, the radio subscription music and non-music content is customized for the user based on inputs further comprising: curation by an administrator, market data, the user's behavior within the application, the behavior of others in the user's social graph, and the user's social activity. In some embodiments, the interface allowing a user to set music content preferences allows the user to select or delete songs from a list of songs derived from selected styles and genres. In some embodiments, the interface allowing a user to adjust a mix of music styles and a mix of music to non-music content in the radio subscription comprises slider interface elements to adjust each mix. In some embodiments, the programming clock comprises a circular interactive interface allowing the user to replay played content and jump ahead to upcoming content within a programming hour. In some embodiments, the non-music content schedule comprises one or more preferred days of the week and a preferred time of day.

In another aspect, disclosed herein are computer-implemented methods of providing a micro-customizable radio subscription service comprising: presenting, at a mobile device, an interface allowing a user to set music content preferences by selecting one or more styles and one or more genres; presenting, at the mobile device, an interface allowing a user to set non-music content preferences by selecting one or more genres and setting a non-music content schedule; presenting, at the mobile device, an interface allowing a user to adjust a mix of music styles and a mix of music to non-music content in the radio subscription; customizing, at a server, radio subscription music and non-music content for the user based on the preferences and the mixes; and delivering, to the mobile device from the server, the customized radio subscription music and non-music content to the mobile application via download with pre-payment of digital rights, wherein the content is available for offline playback; and presenting, at the mobile device, a programming clock showing played and upcoming music and non-music content for each hour. In some embodiments, the radio subscription music and non-music content is customized for the user based on inputs comprising: curation by an administrator, market data, the user's behavior within the application, the behavior of others in the user's social graph, and the user's social activity. In some embodiments, the interface allowing a user to set music content preferences allows the user to select or delete songs from a list of songs derived from selected styles and genres. In some embodiments, the interface allowing a user to adjust a mix of music styles and a mix of music to non-music content in the radio subscription comprises slider interface elements to adjust each mix. In some embodiments, the programming clock comprises a circular interactive interface allowing the user to replay played content and jump ahead to upcoming content within a programming hour. In some embodiments, the non-music content schedule comprises one or more preferred days of the week and a preferred time of day.

### BRIEF DESCRIPTION OF THE DRAWINGS

FIG. 1A shows a non-limiting example of a user interface for a micro-customizable radio subscription service; in this case, a login screen configured to allow the user to login to the service with a username and password; or to register for the service by signing up.

FIG. 1B shows a non-limiting example of a user interface for a micro-customizable radio subscription service; in this case, a sign-up screen configured to allow the user to enter in personal information and select a password.

FIG. 2A shows a non-limiting example of a user interface for a micro-customizable radio subscription service; in this case, a music genre selection screen configured to allow the user to select from many genres.

FIG. 2B shows a non-limiting example of a user interface for a micro-customizable radio subscription service; in this case, a music style selection screen configured to allow the user to select from many styles.

FIG. 3A shows a non-limiting example of a user interface for a micro-customizable radio subscription service; in this case, a song selection screen configured to allow for the selection of songs from a list.

FIG. 3B shows a non-limiting example of a user interface for a micro-customizable radio subscription service; in this case, a song selection screen configured to allow for the removal of songs from a song list.

FIG. 4A shows a non-limiting example of a user interface for a micro-customizable radio subscription service; in this case, a user interface for a non-music content selection screen configured to allow the user to select from many genres.

FIG. 4B shows a non-limiting example of a user interface for a micro-customizable radio subscription service; in this case, a user interface for a non-music content selection screen displaying selection options for non-music content.

FIG. 5A shows a non-limiting example of a user interface for a micro-customizable radio subscription service; in this case, a user interface for a non-music content scheduling screen configured to allow the user to select the day of the week and the time of day for playback.

FIG. 5B shows a non-limiting example of a user interface for a micro-customizable radio subscription service; in this case, a user interface for a mix adjustment screen configured to allow the user to adjust the frequency of playback for music genres, music styles, and non-music content.

FIG. 6 shows a non-limiting example of a user interface for a micro-customizable radio subscription service; in this case, a user interface for a media playback screen displaying the current music content or non-music content playing and providing the user with content setting options for changing content preferences.

FIG. 7A shows a non-limiting example of a user interface for a micro-customizable radio subscription service; in this case, a user interface for a programming clock configured with a circular interactive interface that displays played and upcoming music and non-music content.

FIG. 7B shows a non-limiting example of a user interface for a micro-customizable radio subscription service; in this case, a user interface for a programming clock expanded to display individual played and upcoming music and non-music content for each hour.

FIG. 8 shows a non-limiting example of a user interface for a micro-customizable radio subscription service; in this case, a user interface for a song selection screen configured to allow the user to select a song or songs by artist and add the selection to a playlist or playlists.

FIG. 9 shows a non-limiting example of a diagram pertaining to a micro-customizable radio subscription; in this case, a diagram describing a process for generating a playlist.

FIG. 10 shows a non-limiting example of a flowchart pertaining to a micro-customizable radio subscription; in this case, a flow chart describing a process for generating a playlist.

### DETAILED DESCRIPTION OF THE INVENTION

Described herein, in certain embodiments, are computer-implemented systems comprising: a digital processing device comprising an operating system configured to perform executable instructions and a memory; a computer program including instructions executable by the digital processing device to create a micro-customizable radio subscription application comprising: a software module presenting an interface allowing a user to set music content preferences by selecting one or more styles and one or more genres; a software module presenting an interface allowing a user to set non-music content preferences by selecting one or more genres and setting a non-music content schedule; a software module presenting an interface allowing a user to adjust a mix of music styles and a mix of music to non-music content in the radio subscription; and a software module presenting a programming clock showing played and upcoming music and non-music content, based on the preferences, the mixes, and the schedule, for each hour; provided that the radio subscription music and non-music content is downloaded with pre-payment of digital rights and is available for offline playback.

Also described herein, in certain embodiments, are micro-customizable radio subscription platforms comprising: a mobile processor configured to provide a mobile application comprising: a software module presenting an interface allowing a user to set music content preferences by selecting one or more styles and one or more genres; a software module presenting an interface allowing a user to set non-music content preferences by selecting one or more genres and setting a non-music content schedule; a software module presenting an interface allowing a user to adjust a mix of music styles and a mix of music to non-music content in the radio subscription; and a software module presenting a programming clock showing played and upcoming music and non-music content, based on the preferences, the mixes, and the schedule, for each hour; a server processor configured to provide a server application comprising: a software module customizing radio subscription music and non-music content for the user based on the preferences and the mixes; and a software module delivering the customized radio subscription music and non-music content to the mobile application via download with pre-payment of digital rights, wherein the content is available for offline playback.

Also described herein, in certain embodiments, are non-transitory computer-readable storage media encoded with a computer program including instructions executable by a processor to create a micro-customizable radio subscription application comprising: a software module presenting an interface allowing a user to set music content preferences by selecting one or more styles and one or more genres; a software module presenting an interface allowing a user to set non-music content preferences by selecting one or more genres and setting a non-music content schedule; a software module presenting an interface allowing a user to adjust a mix of music styles and a mix of music to non-music content in the radio subscription; a software module presenting a programming clock showing played and upcoming music and non-music content, based on the preferences, the mixes, and the schedule, for each hour; and a software module provided that downloading the radio subscription music and non-music content with pre-payment of digital rights such that the content is available for offline playback.

Also described herein, in certain embodiments, are computer-implemented methods of providing a micro-customizable radio subscription service comprising: presenting, at a mobile device, an interface allowing a user to set music content preferences by selecting one or more styles and one or more genres; presenting, at the mobile device, an interface allowing a user to set non-music content preferences by selecting one or more genres and setting a non-music content schedule; presenting, at the mobile device, an interface allowing a user to adjust a mix of music styles and a mix of music to non-music content in the radio subscription; customizing, at a server, radio subscription music and non-music content for the user based on the preferences and the mixes; and delivering, to the mobile device from the server, the customized radio subscription music and non-music content to the mobile application via download with pre-payment of digital rights, wherein the content is available for offline playback; and presenting, at the mobile device, a programming clock showing played and upcoming music and non-music content for each hour.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Micro-Customizable Radio Subscription

In some embodiments, the systems, media, methods, and platforms described herein include a micro-customizable radio subscription, or use of the same. In some embodiments, the micro-customizable radio subscription is a radio stream that is optionally played through an Internet connection. In other embodiments, the micro-customizable radio subscription is a radio stream that is optionally downloaded with prepayment of digital rights and is available for offline playback. In some embodiments, the micro-customizable radio subscription includes tools and elements to enable users to create and set music content preferences and non-music content preferences. In further embodiments, the micro-customizable radio subscription includes tools and elements to enable music content preferences and non-music content preferences to be set by a music selection algorithm. In various further embodiments, the micro-customizable radio subscription includes tools and elements to enable the music content preferences and non-music content preferences to be scheduled to play through a programming clock. In even further embodiments, the micro-customizable radio subscription includes tools and elements to enable users to replay played content and jump ahead to upcoming content.

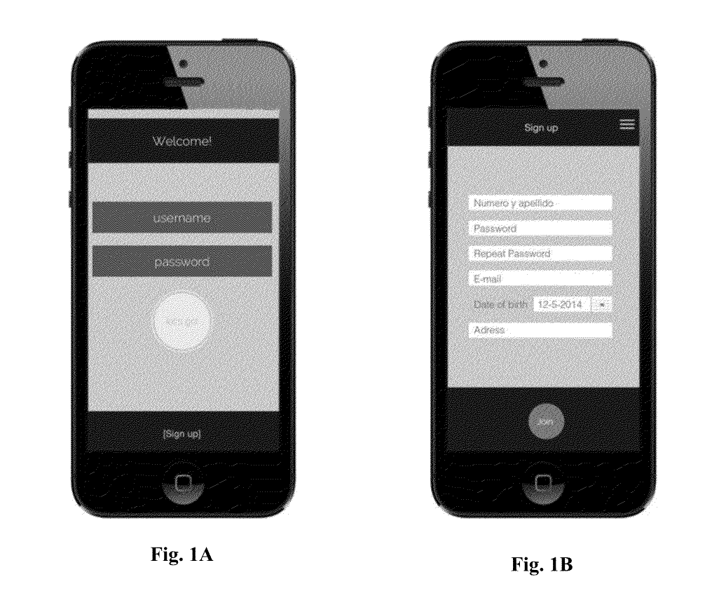

Referring to FIG. 1A, in a particular embodiment, a login screen for the micro-customizable radio subscription service is presented. In this embodiment, the login screen is configured for a user to login using a username and self-selected or auto-generated password. If the user does not have access to the service, the user optionally elects to sign up using the “Sign Up” link provided in the login screen.

Referring to FIG. 1B, in a particular embodiment, a sign up screen for the micro-customizable radio subscription service is presented. In this embodiment, a user signs up for the radio subscription service by providing the user's full name, a self-selected password, the repeated self-selected password, the user's e-mail address, the user's date of birth, and the user's home address.

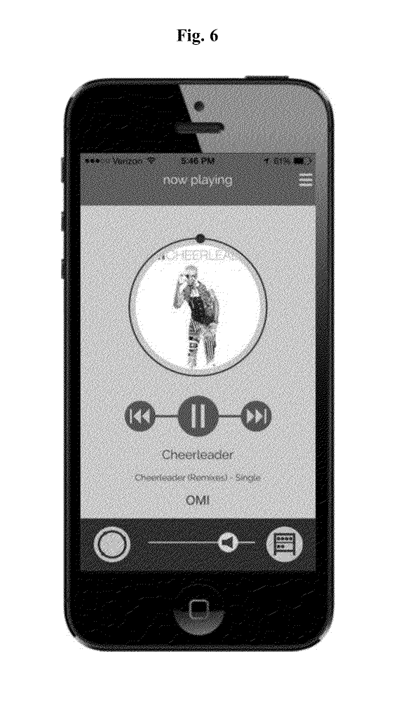

Referring to FIG. 6, in a particular embodiment, the “Now Playing” content play screen for the micro-customizable radio subscription service is presented, which is configured to display the current content and various customizability options. In this embodiment, the current content is associated with the content artwork displayed in the center circle of the screen. The current content is surrounded by the programming clock, represented by the circular dial interface surrounding the content artwork. In the programming clock, the current content is represented by the dot in the circular dial interface, representing the time the content is being played within the hour. In this embodiment, the content play screen is configured with customization options for playback, volume, and menu selection. For playback, the user optionally selects to rewind the current content, replay previous content, pause the content, scrub forward in the content, or skip the current content. The user slides volume indicator, represented by the speak icon, along the sliding scale to adjust the volume of the current content. The user optionally enters into other customization options by selecting icons in the user interface.

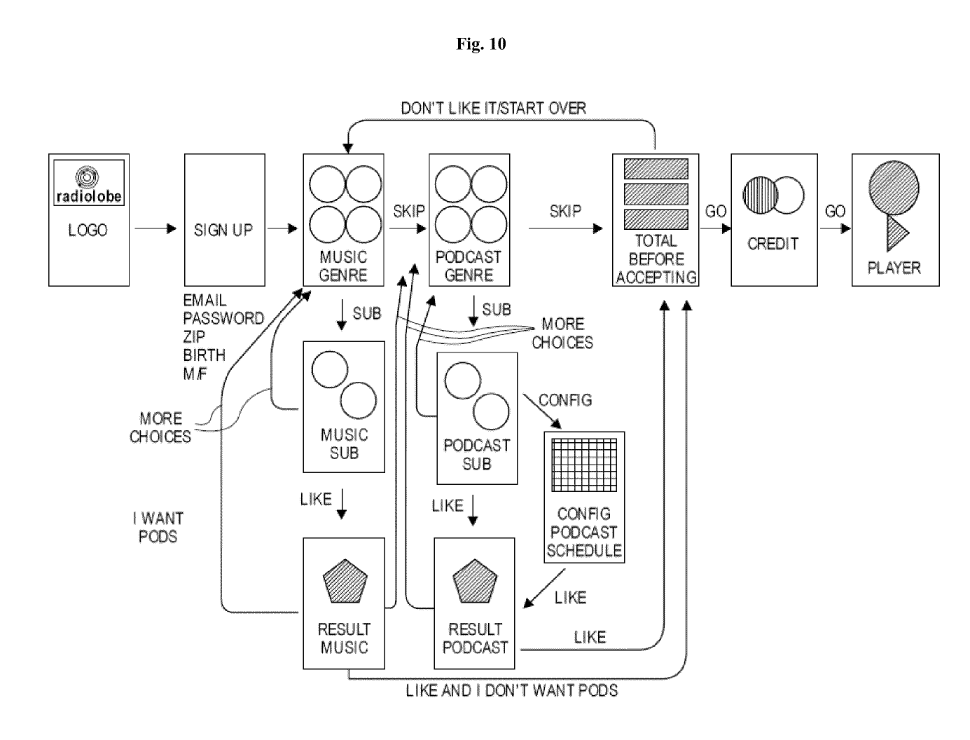

Referring to FIG. 10, in a particular embodiment, a flow chart for the systems, media, methods, and platforms of the micro-customizable radio subscription service is provided. In this embodiment, a user signs up for the micro-customizable radio subscription and selects music content preferences. The user optionally selects non-music content preferences. The user input or music selection algorithm or a combination thereof, generates a playlist from the selections.

### Music Content Preferences

In some embodiments, the systems, media, methods, and platforms described herein include an interface allowing a user to set music content preferences by selecting one or more styles and one or more genres, or use of the same. In some embodiments, the music content preferences are set by a user. In other embodiments, the music content preferences are set by a music selection algorithm. In various embodiments, music content preferences include, by way of non-limiting examples, searching, selecting, displaying, adding, or removing content by the artist, album, song, writer, producer, label, language, release date, decade, genre, style, or combinations thereof, of the music content. In various other embodiments, music content preferences include the ability to select or delete songs from a playlist.

Many suitable implementations of selecting the styles and genres are contemplated, including, but not limited to, tiles, content, details, list, and icons. In some embodiments, the icons are optionally sized, including, but not limited to, small, medium, large, and extra-large. In some embodiments, those of skill in the art will recognize that suitable music genres include, by way of non-limiting examples, Alternative, Blues, Children's Music, Classical, Country, Easy Listening, Electronic, Electronic Dance Music/EDM/Dance, Folk, Hip-Hop/Rap, Holiday, Indie, Inspirational, Instrumental, J-Pop, Jazz, K-Pop, Karaoke, Latin, New Age, Pop, R&B/Soul, Rock, Soundtrack, Vocal, and World/International. In various further embodiments, those of skill in the art will recognize that suitable music styles of the “Alternative” genre include, by way of non-limiting examples, Art Punk, Alternative Rock, College Rock, Experimental Rock, Gothic Rock, Grudge, Hardcore Punk, Hard Rock, Indie Rock, New Wave, Progressive Rock, and Punk. In various further embodiments, those of skill in the art will recognize that suitable music styles of the “Blues” genre include, by way of non-limiting examples, Acoustic Blues, Chicago Blues, Classic Blues, Club Blues, Country Blues, Delta Blues, Electric Blues, Jump Blues, and Piedmont Blues. In various further embodiments, those of skill in the art will recognize that suitable music styles of the “Children's Music” genre include, by way of non-limiting examples, Lullabies, Sing-Along, and Stories. In various further embodiments, those of skill in the art will recognize that suitable music styles of the “Classical” genre include, by way of non-limiting examples, Avant-Garde, Baroque, Chamber Music, Chant, Choral, Classical Crossover, High Classical, Impressionist, Madrigals, Medieval, Minimalism, Modern Composition, Opera, Orchestra, Renaissance, Romantic, Symphony, and Wedding Music. In various further embodiments, those of skill in the art will recognize that suitable music styles of the “Country” genre include, by way of non-limiting examples, Alternative Country, Americana, Bakersfield Sound, Bluegrass, Contemporary Bluegrass, Contemporary Country, Country Gospel, Country Pop, Country Rock, Cowboy, Honky Tonk, Outlaw Country, Mountain Music, Nashville Sound, New Traditionalist, Outlaw Country, Rockabilly, Texas Country, Traditional Bluegrass, Traditional Country, Urban Cowboy, Western, and Western Swing. In various further embodiments, those of skill in the art will recognize that suitable music styles of the “Easy Listening” genre include, by way of non-limiting examples, Bop, Lounge, and Swing. In various further embodiments, those of skill in the art will recognize that suitable music styles of the “Electronic” genre include, by way of non-limiting examples, 8 bit, Ambient, Bassline, Break, Chiptune, Crunk, Downtempo, Drum & Bass, Electro, Electro-swing, Electronica, Electroacoustic, Electronic Rock, Hardstyle, Experimental, Industrial, and Trip Hop. In various further embodiments, those of skill in the art will recognize that suitable music styles of the “Electronic Dance Music/EDM/Dance” genre include, by way of non-limiting examples, Club, Breakbeat, Brostep, Deep House, Dubstep, Electro House, Eurodance, Exercise, Garage, Glitch Hop, Hardcore, Hard Dance, House, Jungle, Post-disco, Techno, Trance, Trap, and UK Garage. In various further embodiments, those of skill in the art will recognize that suitable music styles of the “Hip-Hop” genre include, by way of non-limiting examples, Alternative Rap, Bounce, Dirty South, East Coast Rap, Crunk, Gangsta Rap, Hardcore Rap, Hip-Hop, Latin Rap, Old School Rap, Political Rap, Rap, Turntable, Underground Rap, and West Coast Rap. In various further embodiments, those of skill in the art will recognize that suitable music styles of the “Holiday” genre include, by way of non-limiting examples, Chanukah, Christmas, Easter, Halloween, Thanksgiving, and Other. In various further embodiments, those of skill in the art will recognize that suitable music styles of the “Inspirational” genre include, by way of non-limiting examples, Christian Metal, Christian Pop, Christian Rap, Christian Rock, Classic Christian, Contemporary Gospel, Gospel, Praise and Worship, Southern Gospel, and Traditional Gospel. In various further embodiments, those of skill in the art will recognize that suitable music styles of the “Instrumental” genre include, by way of non-limiting examples, March and Orchestra. In various further embodiments, those of skill in the art will recognize that suitable music styles of the “J-Pop” genre include, by way of non-limiting examples, J-Rock, J-Synth, J-Ska, and J-Punk. In various further embodiments, those of skill in the art will recognize that suitable music styles of the “Jazz” genre include, by way of non-limiting examples, Avant-Garde Jazz, Bebop, Big Band, Blue Note, Chicago Style Jazz, Contemporary Jazz, Cool, Crossover Jazz, Dixieland, Ethio Jazz, Fusion Jazz, Gypsy Jazz, Hard Bop, Latin Jazz, Mainstream Jazz, New Orleans Jazz, Ragtime, Smooth Jazz, and Traditional Jazz. In various further embodiments, those of skill in the art will recognize that suitable music styles of the “Latin” genre include, by way of non-limiting examples, Abozao, Albazo, Aguinaldo, Aire Pampeano, Arunguita, Alterlatino, Arrocha, Avanzada, Axé, Bachata, Baguala, Bailecito, Balada Romántica, Bambuco, Banda Sinaloense, Batucada, Beguine, Bolero, Bolero Moruno, Bolero Ranchero, Bolero Son, Bomba, Bomba del Chota, Boogaloo, Bossa Nova, Bullerengue, Bunde Chocoano, Bunde Tolimense, Brega, Calipso, Canto Cardenche, Cachaca, Capishca, Chilena Género, Chuchumbé, Carnavalito, Carranga, Caña, Ciranda, Chicha, Chimayche, Chirimía, Currulao, Carnavalito, Chacarera, Chorrillero, Chorinho, Cielito, Cifra, Cueca, Cueca Brava, Cueca Nortina, Cueca Porteña, Cuándo, Candombe, Chachachá, Chamamé, Chamarrita, Chotis, Champeta, Chandé, Chicha, Choro, Congos, Corridos, Cuarteto, Cumbia, Cumbia Andina, Cumbia Argentina, Cumbia Boliviana, Cumbia Chilena, Cumbia Colombiana, Cumbia Mexicana, Cumbia Norteña, Cumbia Panameña, Cumbia Peruana, Cumbia Pop, Cumbia Salvadoreña, Cumbia Sureña, Cumbia Venezolana, Cumbia Villera, Nueva Cumbia Chilena, Tecnocumbia, Chachachá, Danzón, Dianas, Duranguense, Escondido, Funk Carioca, Frevo, Forró, Fusión Latinoamericana, Galopa Misionera, Galerón, Golpe Tocuyano, Gaita Zuliana, Gato Cuyano, Gato, Gauchito, Guajira, Guaracha Santiagueña, Guarania, Grupero, Guabina, Guaguancó, Guaracha, Habanera, Hip Hop Latino, Huayno, Huella, Huapango, Jamaquello, Jazz Latino, Jarabe, Jarabe Mixteco, Jarabe Tapatío, Joropo, Jongo, Konpa Dirèk, Lambada, Landó, Loncomeo, Mambo, Mapalé, Mariachi, Maracatu, Mayapax, Música de Marimba Mexicana, Milonga, Milonga-candombe, Milongón, Música Litoraleña, Manguebeat, Maxixe, Mejorana o Socavón, Merengue, Modinha, Murga, Mapalé, Merecumbé, Música de Carrilera, Música Andina, Música Sertaneja, Música Tropical, Mambo, Música Popular Brasileira, Merengue, Música Tejana, Neofolklore, Norteño, Nortec, Nueva Canción, Nueva Trova, Pachanga, Pagode, Papayera, Pasillo, Pasacalle, Patacoré, Pirekua, Plena, Polo, Porro, Pachanga, Palo de Mayo, Payada, Perico Ripiao, Pindin, Polka Norteña Nicaragüense, Polka Paraguaya, Polca en Uruguay, Polca en Argentina, Polca en Nicaragua, Polca en México, Punta, Punto Guanacasteco, Punto Panameño, Pop Latino, Ranchera, Rajaleña, Rasguido Doble o Sobrepaso, Reggae en Español, Reguetón, Rock Latino, Rock en Español, Rumba, Saloma Panameña, Salsa, Salsa Romántica, Samba, Samba de Roda, Sanjuanito, Ska, Soca, Sanjuanero Caqueteño, Sanjuanito, Saya, Son Arribeño, Son de Artesa, Son de Tamborileros de Tabasco, Son Istmeño, Son Jarocho, Son Cubano, Son de Negro, Son Montuno, Son Nica, Songo, Sertanejo, Son Montuno, Tamborera, Tamborito, Timba, Tonada, Tropicalismo, Tango, Tejano, Vidala, Vidalita, Vallenato, Valona, Vals Peruano, Vals Venezolano, Yaraví, Zamacueca, Zamba, Zamba Alegre, Zapateado, Zarzuela, Zemba, and Zouk-Lambada. In various further embodiments, those of skill in the art will recognize that suitable music styles of the “New Age” genre include, by way of non-limiting examples, Environmental, Healing, Meditation, Nature, Relaxation, and Travel. In various further embodiments, those of skill in the art will recognize that suitable music styles of the “Pop” genre include, by way of non-limiting examples, Adult Contemporary, Britpop, Bubblegum Pop, Chamber Pop, Dance Pop, Dream Pop, Electro Pop, Orchestral Pop, Pop Rock, Power Pop, Soft Rock, Synth Pop, and Teen Pop. In various further embodiments, those of skill in the art will recognize that suitable music styles of the “R&B/Soul” genre include, by way of non-limiting examples, Blue-Eyed Soul, Brown-Eyed Soul, Contemporary R&B, Disco, Doo Wop, Funk, Modern Soul, Motown, Neo-Soul, Northern Soul, Nu Disco, Psychedelic Soul, Quiet Storm, Soul, Soul Blues, Southern Soul, and Urban Soul. In various further embodiments, those of skill in the art will recognize that suitable music styles of the “Rock” genre include, by way of non-limiting examples, Acid Rock, Afro Punk, Adult Alternative, Alternative Rock, American Traditional Rock, Anatolian Rock, Arena Rock, Art Rock, Blues Rock, British Invasion, Death Metal/Black Metal, Garage Rock, Glam Rock, Hair Metal, Hard Rock, Heavy Metal, Jam Bands, Progressive Rock, Psychedelic Rock, Punk Rock, Rap Rock, Rock & Roll, Rockabilly, Soft Rock, Southern Rock, Surf, and Tex-Mex. In various further embodiments, those of skill in the art will recognize that suitable music styles of the “Soundtrack” genre include, by way of non-limiting examples, Foreign Cinema, Musicals, Original Score, Soundtrack, and TV Soundtrack. In various further embodiments, those of skill in the art will recognize that suitable music styles of the “Vocal” genre include, by way of non-limiting examples, A Cappella, Barbershop, Doo Wop, Gregorian Chant, Standards, Traditional Pop, Vocal Jazz, and Vocal Pop. In various further embodiments, those of skill in the art will recognize that suitable music styles of the “World/International” genre include, by way of non-limiting examples, Africa, Afro Beat, Afro Pop, Asia, Australia, Cajun, Calypso, Caribbean, Celtic, Celtic Folk, Contemporary Celtic, Dangdut, Drinking Songs, Drone, Europe, France, Hawaii, Indian Ghazal, Indian Pop, Klezmer, Middle East, Ode, Polka, Soca, South Africa, Worldbeat, and Zydeco.

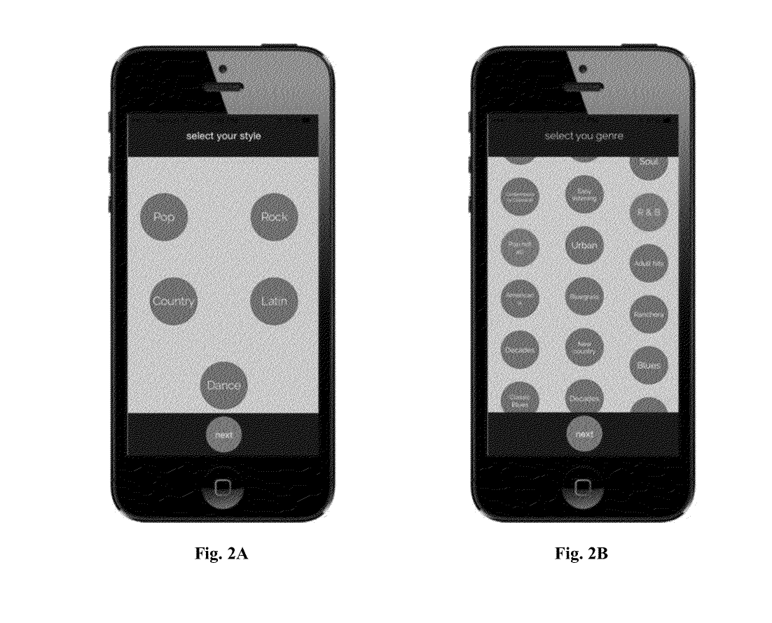

Referring to FIG. 2A, in a particular embodiment, a user interface for selecting genres of music is provided, which is configured to allow the selection of “Pop”, “Rock”, “Country”, “Latin”, “Dance”, or combinations thereof.

Referring to FIG. 2B, in a particular embodiment, a user interface for selecting styles of music is provided, which is configured to allow the selection of “Soul”, “R&B”, “Urban”, “Blues”, and others.

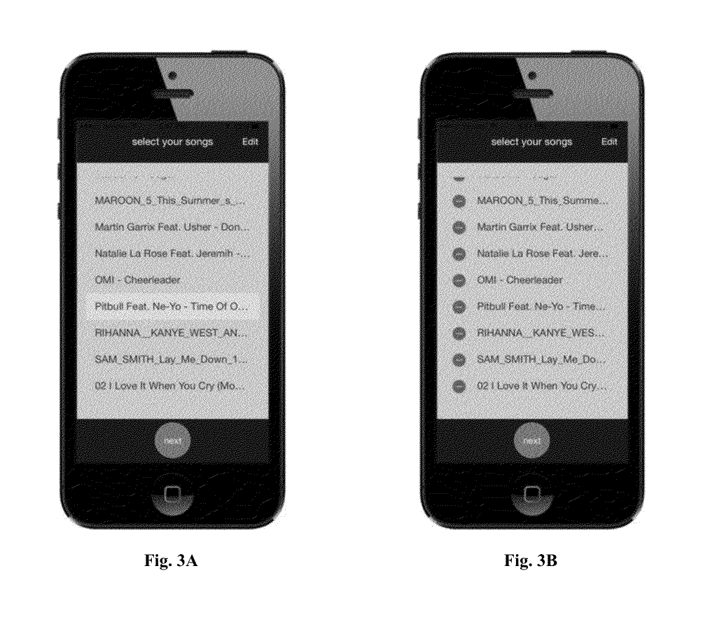

Referring to FIG. 3A, in a particular embodiment, a user interface for selecting songs is provided. In this embodiment, the songs are presented in list form and the user scrolls through the list to view all available songs of a particular genre and style. The user selects one or more songs to edit or add to a playlist.

Referring to FIG. 3B, in a particular embodiment, a user interface for removing songs is provided. In this embodiment, the songs are presented in list form and the user scrolls through the list to view all available songs of a particular genre and style. The user optionally selects “Edit” or swipes right on the interface, which allows the user to remove one or more songs from the song list.

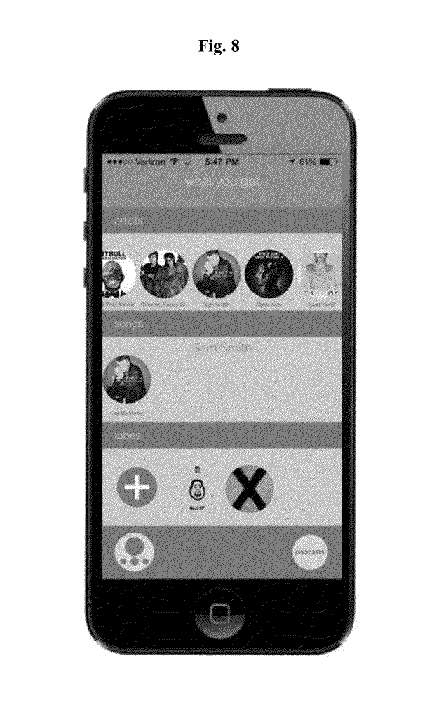

Referring to FIG. 8, in a particular embodiment, a user interface for selecting songs is provided. In this embodiment, the user searches for a song or songs by artist name. The user selects the desired artist to view the available content associated with the selected artist. The user selects the desired song or songs and adds the selections to the “Lobes” playlist or playlists. In this embodiment, the artist, song, and playlist content is presented in icon form and the user scrolls through the icons to view all available artists, songs, and playlists. The user is further able to access customization options by selecting icons in the user interface, which are configured to access the programming clock and non-music content preferences.

### Non-Music Content Preferences

In some embodiments, the systems, media, methods, and platforms described herein include an interface allowing a user to set non-music content preferences by selecting one or more genres and setting a non-music content schedule, or use of the same. In some embodiments, the non-music content preferences are set by a user. In other embodiments, the non-music content preferences are set by a music selection algorithm. In various embodiments, non-music content preferences include, by way of non-limiting examples, searching, selecting, displaying, adding, or removing content by the host, speaker, writer, producer, label, language, date, genre, or combinations thereof, of the non-music content. In various other embodiments, non-music content preferences include the ability to select or delete content from a playlist. In even further embodiments, non-music content preferences include the ability to schedule the day of the week, date, and time for non-music content playback.

Many suitable implementations of selecting the genres are contemplated, including, but not limited to, tiles, content, details, list, and icons. In some embodiments, the icons are optionally sized, including, but not limited to, small, medium, large, and extra-large. In various embodiments, those of skill in the art will recognize that suitable non-music genres include, by way of non-limiting examples, News, Local News, National News, International News, Business, Comedy, Sports, Religion, Economy, Health, Science and Technology, Money, Travel, Living, Politics, Talk, and Entertainment.

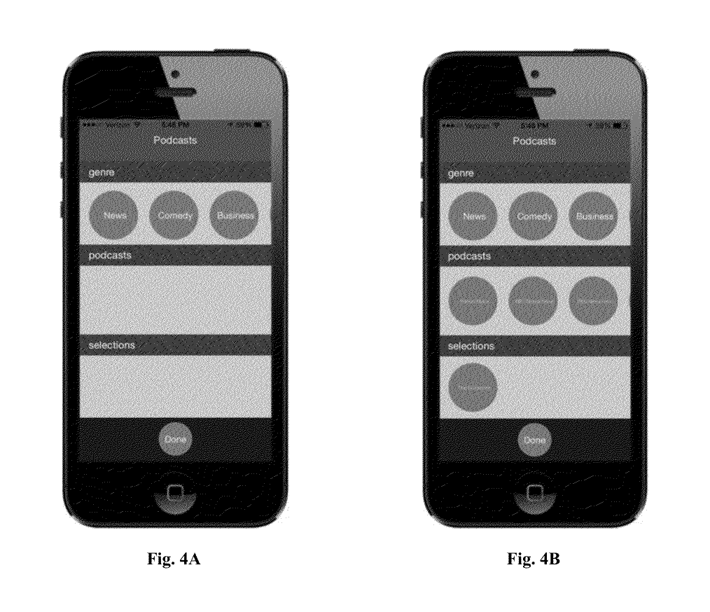

Referring to FIG. 4A, in a particular embodiment, a user interface for selecting non-music content is provided. In this embodiment, the genres of non-music content are presented in icon form and the user scrolls through the icons to view all available genres of non-music content. The user selects the desired genre to view available content within the selected genre.

Referring to FIG. 4B, in a particular embodiment, a user interface for selecting non-music content is provided. In this embodiment, the user selects a genre of non-music content. A series of available podcasts from the selected genre is displayed in icon form and the user scrolls through the icons to view all available podcasts in the selected genre. The user selects one or more of the podcasts to add to a playlist by pressing “Done”.

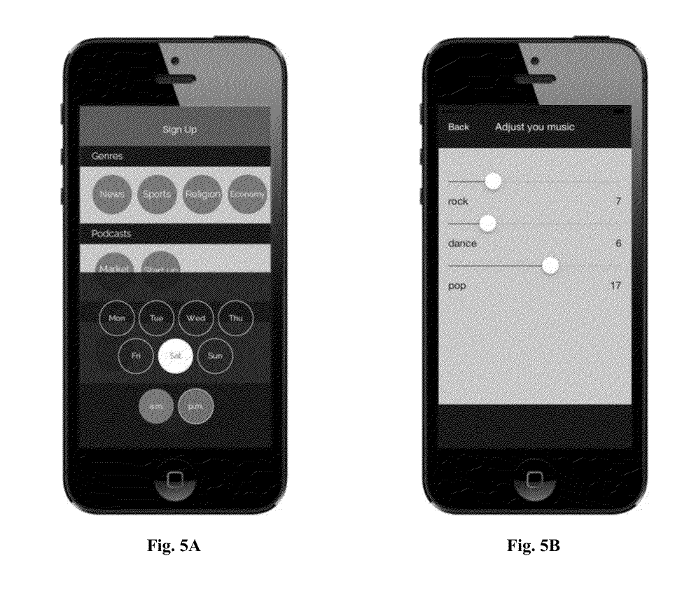

Referring to FIG. 5A, in a particular embodiment, a non-music content scheduling interface is configured to allow the user to select the day of the week and the time of day to play selected non-music content.

### Music Selection Algorithm

In some embodiments, the systems, media, methods, and platforms described herein include an algorithm to select music and non-music content, or use of the same. In various embodiments, the data pertaining to curation by an administrator, market data, the user's behavior within the application, the behavior of others in the user's social graph, the user's social activity, or combinations thereof, are analyzed by the music selection algorithm in generating a playlist of music and non-music content. In some embodiments, the music selection algorithm optionally uses curation by an administrator as a factor in generating a playlist, through analysis of the selection, preservation, maintenance, collection, and archiving of music records. In other embodiments, the music selection algorithm optionally uses market data as a factor in generating a playlist, including music and non-music content sales, awards, news, articles, performance, popularity, or combinations thereof. In further embodiments, the music selection algorithm optionally uses the user's behavior within the application as a factor in generating a playlist, including music and non-music content number of plays, repeats, skips, searches, selections, rankings, ratings, or combinations thereof.

In various embodiments, a user's social graph from Facebook, Twitter, Instagram, LinkedIn, WhatsApp, WeChat, Sina Weibo, or combinations thereof, are tracked, stored, and analyzed. A user's social graph, by way of non-limiting examples, includes friend activity, friend likes, friend comments, group likes, group activity, followed posts, posts from followers, or combinations thereof. In various further embodiments, a user's social activity from Facebook, Twitter, Instagram, LinkedIn, WhatsApp, WeChat, Sina Weibo, or combinations thereof, are tracked, stored, and analyzed. A user's social activity, by way of non-limiting examples, includes viewing, sharing, liking, commenting, following, or combinations thereof.

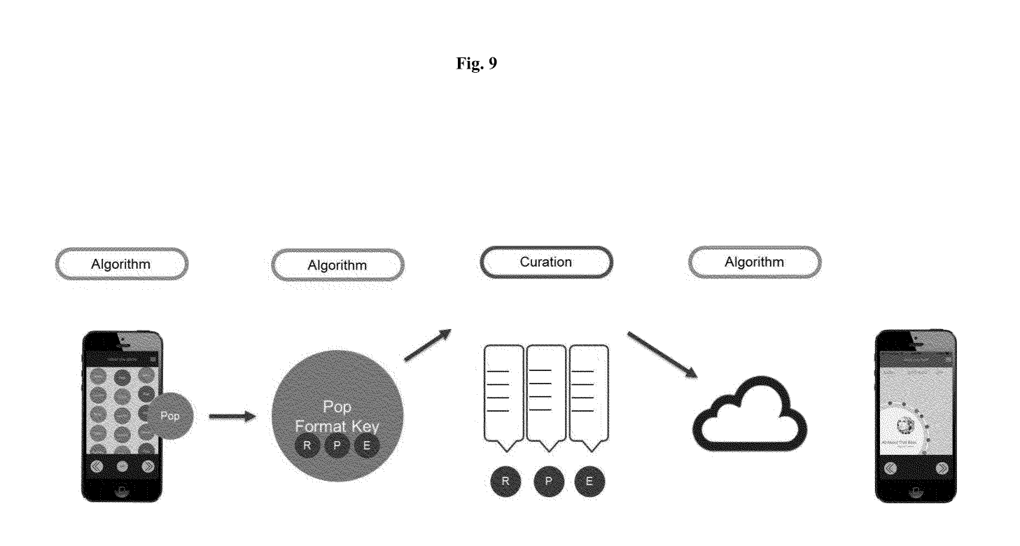

Referring to FIG. 9, in a particular embodiment, a process for generating a playlist is provided, which is configured to track a user's music content and non-music content selection and processed through a music selection algorithm. In this embodiment, the algorithm generates a playlist by analyzing administrator curation, market data, the user's behavior within the application, the behavior of others in the user's social graph, and the user's social activity.

### Mix

In some embodiments, the systems, media, methods, and platforms described herein include an interface allowing a user to adjust a mix of music styles and a mix of music to non-music content in the radio subscription, or use of the same. In some embodiments, the mix of music to non-music content is set by a user. In other embodiments, the mix of music to non-music content is set by a music selection algorithm. In various embodiments, the mix is manually adjusted or automatically adjusted or a combination thereof. In various further embodiments, the mix interface is displayed as a sliding scale, a graph, a chart, a pie chart, a number, a percentage, or a combination thereof.

Referring to FIG. 5B, in a particular embodiment, a mixer interface is provided, which is configured to adjust the frequency of playback for music genres, music styles, and non-music content. In this embodiment, the user adjusts the sliding scale mixer for the selected genres, “Rock”, “Dance”, and “Pop”.

### Programming Clock

In some embodiments, the systems, media, methods, and platforms described herein include a programming clock showing played and upcoming music and non-music content, based on the preferences, the mixes, and the schedule, for each hour, or use of the same. In some embodiments, the programming clock is displayed as a circular interactive interface. The circular interactive interface is configured such that the user accesses the music and non-music content to view, add, remove, or edit the content. In further embodiments, the circular interactive interface is configured to show the music and non-music content schedule for an hour. In even further embodiments, the music and non-music content in the circular interactive interface is represented by, by way of non-limiting examples, dots, symbols, icons, text, or a combination thereof. In various embodiments, the programming clock is optionally displayed as a list, graph, calendar, or chart.

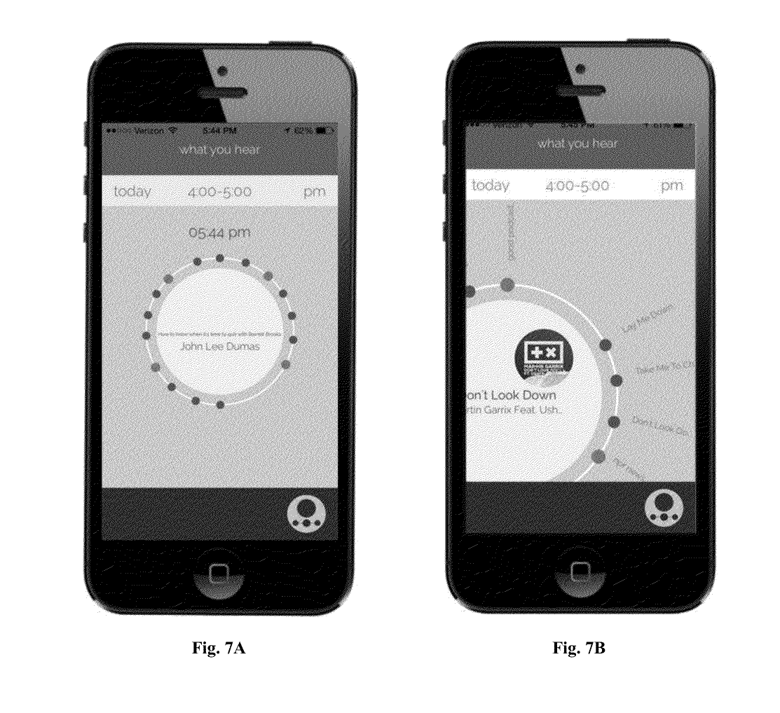

Referring to FIG. 7A, in a particular embodiment, a user interface for a programming clock is provided, configured with a circular interactive interface allowing the user to replay played content and jump ahead to upcoming content within a programming hour. In this embodiment, the programming hour is displayed as text and as a circular interactive interface. The current time is displayed above the circular interactive interface and the current content selected is displayed within the circular interactive interface. The dots along the circular interactive interface represent the time within the hour in which played or upcoming content begins. The user optionally slides along the circular interactive interface or selects the dot icons to replay played content or jump ahead to upcoming content. The user accesses the programming clock options by selecting an icon in the user interface.

Referring to FIG. 7B, in a particular embodiment, a user interface for a programming clock is provided, configured with a circular interactive interface allowing the user to replay played content and jump ahead to upcoming content within a programming hour. In this embodiment, an expanded view of the circular interactive interface is presented. The current content selected is displayed within the circular interactive interface. The dots along the circular interactive interface represent the time within the hour in which played or upcoming content begins. In the expanded view, the content title represented by the dot is displayed adjacent to the dot. The user optionally slides along the circular interactive interface or selects the dot icons to replay played content or jump ahead to upcoming content. The user accesses the programming clock options by selecting an icon in the interface.

### Digital Processing Device

In some embodiments, the systems, media, methods, and platforms described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple iOS®, Research In Motion® BlackBerry OS®, Google® Android®, Microsoft® Windows Phone® OS, Microsoft® Windows Mobile OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the systems, media, methods, and platforms disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, media, methods, and platforms disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the systems, media, methods, and platforms disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the systems, media, methods, and platforms disclosed herein include one or more databases, or use of the same. In view of the disclosure provided herein, those of skill in the art will recognize that many databases are suitable for storage and retrieval of user, preference, genre, style, music, and non-music content information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

### Creating a Daily Schedule

Husband and wife carpool together to work. They agree to listen to husband's preferences on the way to work and to listen to wife's preferences on the way home from work. Husband prefers to listen to mostly news, with a few dance songs in between. Wife prefers only music and enjoys metal and surf music. Husband uses the micro-customizable radio subscription service described herein that is installed on his Apple iPad and selects music genre “Electronic” and music style “Trance”. Husband also selects non-music content genre “News”. Husband sets his mix to approximately 80% “Local News” and approximately 20% “Trace”. Husband sets the programming clock to play this mix from 7:00 A.M. to 9:00 A.M. on weekdays. Husband then chooses music genre “Rock” and selects styles “Heavy Metal” and “Surf”. He sets the mix to half and half and programs this mix to play between 5:00 P.M to 7:00 P.M. on weekdays.

### Example 2

### Playing Played and Upcoming Content

Husband and wife from Example 1 decide to switch their broadcasting schedules while on the way to work. Husband will now listen to his content in the evenings and wife will listen to her content in the mornings. In the programming clock, wife jumps ahead to upcoming content to listen to her scheduled 5:00 P.M. content in the morning. Conversely, husband replays his 7:00 A.M. content while driving home from work. Husband and wife elect to reprogram the mixes to correspond to this new listening schedule that evening.

### Example 3

### Scheduling Multiple Playbacks

A new hit song is released. The song belongs to the style “Latin” and the genre “Reggaeton”. A dancer is addicted to the song and wants to listen to it on repeat playback throughout Friday night while she is sleeping. She uses the micro-customizable radio subscription service described herein that is installed on her Samsung mobile device and selects music genre “Latin” and music style “Reggaeton”. She searches for the song by artist and album and selects the song. She adds the song to her playlist for Friday, programming the song to be played on repeat beginning at 11:00 P.M. on Friday and ending at 8:00 A.M. on Saturday.

### Example 4

### Curation of an Active Playlist

A student previously created a mix in the herein described micro-customizable radio subscription service. The student has listened to the same mix for three months; however, she has made hundreds of new friends during her first year of university classes. As a result of her new social activity, her preferences in music content and non-music content have somewhat shifted. She is repeating songs in the “Pop” music genre and skipping past songs in the “Country” music genre. Her micro-customizable radio subscription service is linked to her social media networks, wherein her friends are sharing more data related to the “Pop” music genre and the “Entertainment News” non-music genre. As a result of the gathered, the music selection algorithm curates the playlist to include less “Country” music and more “Pop” music, and it further adds “Entertainment News” into the playlist mix.

### Example 5

### Traveling with the Radio Service

A sailor is planning a sailing trip between Argentina and South Africa. She expects the trip to take 60 days. She logs in to the herein described micro-customizable radio subscription service on her Microsoft Windows computer and selects numerous music content styles and genres and non-music content, combined in a variety of mixes set to play at different times in the programming clock. She is afraid that she will have limited Internet connection while on her boat. She chooses to download her music and non-music content with prepayment of digital rights and saves the files onto a memory device. She now has access to all of her music and non-music content for uninterrupted play during her 60 day trip, even if she loses Internet connection during long stretches of the trip.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented system comprising:
a) a digital processing device comprising an operating system configured to perform executable instructions and a memory;
b) a computer program including instructions executable by the digital processing device to create a micro-customizable radio subscription application comprising:
i) a software module presenting an interface allowing a user to set music content preferences by selecting one or more styles and one or more genres;
ii) a software module presenting an interface allowing a user to set non-music content preferences by selecting one or more genres and setting a non-music content schedule;
iii) a software module presenting an interface allowing a user to adjust a mix of music styles and a mix of music to non-music content in the radio subscription; and
iv) a software module presenting a programming clock showing played and upcoming music and non-music content, based on the preferences, the mixes, and the schedule, for each hour;
provided that the radio subscription music and non-music content is downloaded with pre-payment of digital rights and is available for offline playback.

2. The system of claim 1, wherein the radio subscription music and non-music content is customized for the user based on inputs comprising: the preferences and the mixes.

3. The system of claim 2, wherein the radio subscription music and non-music content is customized for the user based on inputs further comprising: curation by an administrator, market data, the user's behavior within the application, the behavior of others in the user's social graph, and the user's social activity.

4. The system of claim 1, wherein the interface allowing a user to set music content preferences allows the user to select or delete songs from a list of songs derived from selected styles and genres.

5. The system of claim 1, wherein the interface allowing a user to adjust a mix of music styles and a mix of music to non-music content in the radio subscription comprises slider interface elements to adjust each mix.

6. The system of claim 1, wherein the programming clock comprises a circular interactive interface allowing the user to replay played content and jump ahead to upcoming content within a programming hour.

7. The system of claim 1, wherein the non-music content schedule comprises one or more preferred days of the week and a preferred time of day.

8. A micro-customizable radio subscription platform comprising:
a. a mobile processor configured to provide a mobile application comprising:
i) a software module presenting an interface allowing a user to set music content preferences by selecting one or more styles and one or more genres;
ii) a software module presenting an interface allowing a user to set non-music content preferences by selecting one or more genres and setting a non-music content schedule;
iii) a software module presenting an interface allowing a user to adjust a mix of music styles and a mix of music to non-music content in the radio subscription; and
iv) a software module presenting a programming clock showing played and upcoming music and non-music content, based on the preferences, the mixes, and the schedule, for each hour;
b. a server processor configured to provide a server application comprising:
i) a software module customizing radio subscription music and non-music content for the user based on the preferences and the mixes; and
ii) a software module delivering the customized radio subscription music and non-music content to the mobile application via download with pre-payment of digital rights, wherein the content is available for offline playback.

9. The platform of claim 8, wherein the radio subscription music and non-music content is customized for the user based on inputs comprising: curation by an administrator, market data, the user's behavior within the application, the behavior of others in the user's social graph, and the user's social activity.

10. The platform of claim 8, wherein the interface allowing a user to set music content preferences allows the user to select or delete songs from a list of songs derived from selected styles and genres.

11. The platform of claim 8, wherein the interface allowing a user to adjust a mix of music styles and a mix of music to non-music content in the radio subscription comprises slider interface elements to adjust each mix.

12. The platform of claim 8, wherein the programming clock comprises a circular interactive interface allowing the user to replay played content and jump ahead to upcoming content within a programming hour.

13. The platform of claim 8, wherein the non-music content schedule comprises one or more preferred days of the week and a preferred time of day.

14. Non-transitory computer-readable storage media encoded with a computer program including instructions executable by a processor to create a micro-customizable radio subscription application comprising:
a) a software module presenting an interface allowing a user to set music content preferences by selecting one or more styles and one or more genres;
b) a software module presenting an interface allowing a user to set non-music content preferences by selecting one or more genres and setting a non-music content schedule;
c) a software module presenting an interface allowing a user to adjust a mix of music styles and a mix of music to non-music content in the radio subscription;
d) a software module presenting a programming clock showing played and upcoming music and non-music content, based on the preferences, the mixes, and the schedule, for each hour; and
e) a software module provided that downloading the radio subscription music and non-music content with pre-payment of digital rights such that the content is available for offline playback.

15. The media of claim 14, wherein the radio subscription music and non-music content is customized for the user based on inputs comprising: the preferences and the mixes.

16. The media of claim 15, wherein the radio subscription music and non-music content is customized for the user based on inputs further comprising: curation by an administrator, market data, the user's behavior within the application, the behavior of others in the user's social graph, and the user's social activity.

17. The media of claim 14, wherein the interface allowing a user to set music content preferences allows the user to select or delete songs from a list of songs derived from selected styles and genres.

18. The media of claim 14, wherein the interface allowing a user to adjust a mix of music styles and a mix of music to non-music content in the radio subscription comprises slider interface elements to adjust each mix.

19. The media of claim 14, wherein the programming clock comprises a circular interactive interface allowing the user to replay played content and jump ahead to upcoming content within a programming hour.

20. The media of claim 14, wherein the non-music content schedule comprises one or more preferred days of the week and a preferred time of day.

21. A computer-implemented method of providing a micro-customizable radio subscription service comprising:
a) presenting, at a mobile device, an interface allowing a user to set music content preferences by selecting one or more styles and one or more genres;
b) presenting, at the mobile device, an interface allowing a user to set non-music content preferences by selecting one or more genres and setting a non-music content schedule;
c) presenting, at the mobile device, an interface allowing a user to adjust a mix of music styles and a mix of music to non-music content in the radio subscription;
d) customizing, at a server, radio subscription music and non-music content for the user based on the preferences and the mixes;
e) delivering, to the mobile device from the server, the customized radio subscription music and non-music content to the mobile application via download with pre-payment of digital rights, wherein the content is available for offline playback; and
f) presenting, at the mobile device, a programming clock showing played and upcoming music and non-music content for each hour.

22. The method of claim 21, wherein the radio subscription music and non-music content is customized for the user based on inputs comprising: curation by an administrator, market data, the user's behavior within the application, the behavior of others in the user's social graph, and the user's social activity.

23. The method of claim 21, wherein the interface allowing a user to set music content preferences allows the user to select or delete songs from a list of songs derived from selected styles and genres.

24. The method of claim 21, wherein the interface allowing a user to adjust a mix of music styles and a mix of music to non-music content in the radio subscription comprises slider interface elements to adjust each mix.

25. The method of claim 21, wherein the programming clock comprises a circular interactive interface allowing the user to replay played content and jump ahead to upcoming content within a programming hour.

26. The method of claim 21, wherein the non-music content schedule comprises one or more preferred days of the week and a preferred time of day.
